(19) United States
(12) Patent Application Publication
(10) Pub. No.: US 2006/0129949 A1
(43) Pub. Date: Jun. 15, 2006

(54) Multi-window information platform user interface

(76) Inventor: Chien-Li Wu, Taipei (TW)

Correspondence Address: PEARL COHEN ZEDEK, LLP, 1500 BROADWAY 12TH FLOOR, NEW YORK, NY, 10036, US

(21) Appl. No.: 11/011,159

(22) Filed: Dec. 15, 2004

(51) Int. Cl. G06F 17/00

(52) U.S. Cl. 715/804

(57) ABSTRACT

A multi-window information platform user interface is proposed, which is designed for use in conjunction with an information platform, particularly a portable intelligent electronic device, for providing the information platform with a multi-window user interface that allows the user to operate the various functional options of the information platform concurrently through multiple windows. This feature allows the user to more conveniently and efficiently operate the various functional options of the information platform concurrently at the same time, and is therefore more advantageous to use than prior art.

### FIELD OF THE INVENTION

This invention relates to information technology (IT), and more particularly, to a multi-window information platform user interface, which is designed for use in conjunction with an information platform, particularly a portable intelligent electronic device, such as an intelligent mobile phone, a PDA (Personal Digital Assistant) unit, an electronic dictionary device, or the like, for providing the information platform with a multi-window user interface that allows the user to operate the various functional options of the information platform concurrently through multiple windows.

### BACKGROUND OF THE INVENTION

A mobile phone is a portable wireless voice communication device that allows the user to it carry on the road and communicate via voice with either traditional wired telephones or other mobile phones. With new advances and price drops in wireless communication technology, mobile phones are now widely utilized by people of all trades.

In addition, with the advances in information technology, current mobile phones are typically integrated with intelligent functions that allow the user to utilize the mobile phone as a small-scale information platform for operations of computer-related functions, such as sending/receiving short messages, linking to Internet to browse Web pages, capturing digital photos, to name just a few.

In practice, traditional intelligent mobile phones typically utilize a single-window user interface for the user to operate all the mobile phone's intelligent functions, including, for example, a short-message transmitting/receiving function, an Internet browsing function, a wireless voice communication function, a digital camera function, and so on. This single-window user interface can display only one window at a time on the screen, so that when the user wants to operate a first function, the user needs to switch the user interface to the window associated with the first function; and when the user wants to operate a second function, the user needs to switch the user interface to the window associated with the second function.

One drawback to the use of the aforementioned single-window user interface, however, is that when the user wants to operate two or more functions concurrently at the same time, for example checking short messages while browsing the Internet, it requires the user to constantly and repeatedly switch between the respective two windows of these two functions, which is apparently quite laborious and inconvenient.

### SUMMARY OF THE INVENTION

It is therefore an objective of this invention to provide a multi-window information platform user interface for use with an information platform to allow the user to more conveniently and efficiently operate the various functional options of the information platform concurrently through multiple windows that can be displayed concurrently on screen.

The multi-window information platform user interface according to the invention is designed for use in conjunction with an information platform, particularly a portable intelligent electronic device, such as an intelligent mobile phone, a PDA (Personal Digital Assistant) unit, an electronic dictionary device, or the like, for providing the information platform with a multi-window user interface that allows the user to operate the various functional options of the information platform concurrently through multiple windows. This feature allows the user to more conveniently and efficiently operate the various functional options of the information platform concurrently at the same time.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the application architecture and object-oriented component model of the multi-window information platform user interface according to the invention;

FIG. 2A is a schematic diagram showing an example of a parent window displayed on an information platform equipped with the multi-window information platform user interface of the invention; and

FIG. 2B shows the same parent window of FIG. 2A except that two child windows have been opened through the parent window.

### DETAILED DESCRIPTION OF PREFERRED EMBODIMENTS

The multi-window information platform user interface according to the invention is disclosed in full details by way of preferred embodiments in the following with reference to the accompanying drawings.

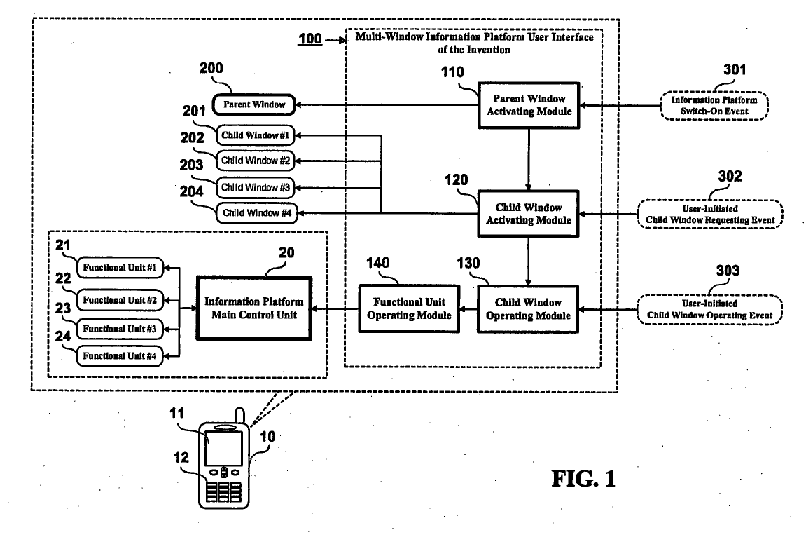

FIG. 1 is a schematic diagram showing the application architecture and object-oriented component model of the multi-window information platform user interface according to the invention (as the part enclosed in the dotted box indicated by the reference numeral 100). As shown, the multi-window information platform user interface of the invention 100 is designed for use with in conjunction with an information platform 10, particularly a portable intelligent electronic device, such as an intelligent mobile phone, a PDA (Personal Digital Assistant) unit, an electronic dictionary device, or the like, that is equipped with a number of functional units 21, 22, 23, 24, with the purpose of providing the information platform 10 with a multi-window user interface that allows the user to operate the functional units 21, 22, 23, 24 concurrently through multiple windows, including at least one parent window 200 and a number of child windows 201, 202, 203, 204 associated with the functional units 21, 22, 23, 24.

For example, in the case of the information platform 10 being an intelligent mobile phone whose internal architecture includes a main control unit 20 and a number of functional units 21, 22, 23, 24 (note that in this example, 4 functional units are used for demonstrative purpose; and fundamentally, the number of the functional units is unrestricted). These functional units 21, 22, 23, 24 are respectively used to provide, for example, a short-message transmitting/receiving function, an Internet browsing function, a wireless voice communication function, and a digital camera function. Traditionally, when the user wants to use these 4 functions at the same time, the user needs to switch between a short-message transmitting/receiving interface, an Internet browsing interface, a wireless voice communication interface, and a digital camera interface, and only one of these interfaces can be displayed at a time. By the invention, however, it allows the information platform 10 to be capable of displaying two or more of the child windows 201, 202, 203, 204 on the screen 11 at the same time for the user to operate two or more of these functional units 21, 22, 23, 24 at the same time. For example, the user can utilize the first child window 201 to operate the short-message transmitting/receiving function, the second child window 202 to operate the Internet browsing function, the third child window 203 to operate the wireless voice communication function, and the fourth child window 204 to operate the digital camera function.

As shown in FIG. 1, the object-oriented component model of the multi-window information platform user interface of the invention 100 comprises: (a) a parent window activating module 110; (b) a child window activating module 120; (c) a child window operating module 130; and (d) a functional unit operating module 140.

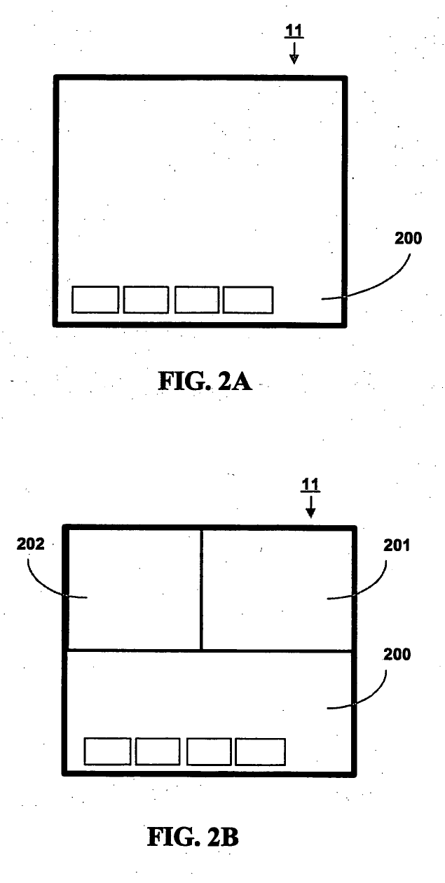

The parent window activating module 110 is capable of being activated in response to a switch-on event 301 on the information platform 10 (i.e., in the event that the power of the information platform 10 is switched on by the user) to display a parent window 200 as schematically illustrated in FIG. 2A on the screen 11 of the information platform 10, with the parent window 200 displaying a number of functional options each corresponding to one of the functional units 21, 22, 23, 24 which are used to provide a number of intelligent functions, such as a short-message transmitting/receiving function, an Internet browsing function, a wireless voice communication function, and a digital camera function. The user can utilize the parent window 200 to initiate a child window requesting event 302 (for example, by pressing a specific key or key combination on the keypad 12) to cause the parent window 200 to respond by issuing a corresponding child window requesting message to the child window activating module 120.

The child window activating module 120 is capable of responding to the child window requesting message from the parent window activating module 110 by activating (i.e., opening) a corresponding child window (such as the first child window 201 shown in FIG. 2B) that is associated with the user-selected functional option. This child window activating module 120 has a multi-window capability that allows it to respond to still another child window requesting event 302 to open another child window (such as the second child window 202 shown in FIG. 2B).

The child window operating module 130 is functionally coupled to the keypad 12 of the information platform 10, which allows the user to utilize the keypad 12 to operate each of the child windows 201,202,203,204 and their associated functional units 21, 22, 23, 24. Operations on the child windows 201, 202, 203, 204 include, for example, scrolling, resizing, relocating, and so on. Further, the user can utilize each opened child window (201, 202,203, or 204) to initiate a child window operating event 303 (for example, by pressing a special key or key combination on the keypad 12) to cause the associated child window (201, 202, 203, or 204) to issue a corresponding function requesting message to the functional unit operating module 140, and the functional unit operating module 140 will respond by activating the associated one of the functional units 21, 22, 23, 24 to perform the user-selected function.

Referring to FIG. 1 together with FIGS. 2A-2B, in practical application, for example, it is assumed that the user wants to utilize the information platform 10 to perform a short-message transmitting/receiving function and an Internet browsing function concurrently at the same time. In this case, the user needs first to switch on the information platform 10, causing the occurrence of a switch-on event 301 on the information platform 10 that automatically activates the parent window activating module 110 to responsively display a parent window 200 on the screen 11 of the information platform 10, as illustrated in FIG. 2A. This parent window 200 allows the user to select his/her desired two functional options, i.e., the short-message transmitting/receiving function and the Internet browsing function.

As the user selects the option of short-message transmitting/receiving function through the parent window 200, it causes the occurrence of a child window requesting event 302 which causes the parent window 200 to responsively issue a corresponding child window requesting message to the child window activating module 120, commanding the child window activating module 120 to open a first child window 201 over the parent window 200 as illustrated in FIG. 2B. Through the first child window 201, the user can initiate a child window operating event 303 to operate its associated functional unit 21 for the desired function, i.e., the short-message transmitting/receiving function.

Subsequently, as the user selects the option of Internet browsing function through the parent window 200, it causes the occurrence of another child window requesting event 302 which causes the parent window 200 to responsively issue a corresponding child window requesting message to the child window activating module 120, commanding the child window activating module 120 to open a second child window 202 over the parent window 200 as illustrated in FIG. 2B. Through the second child window 202, the user can initiate a child window operating event 303 to operate its associated functional unit 22 for the desired function, i.e., the Internet browsing function.

After the first child window 201 and the second child window 202 have been concurrently displayed on the screen 11, the user can utilize the first child window 201 to check short-messages while browsing the Internet through the second child window 202. If the user wants to utilize other functional options, the user can similarly open another child window through the parent window 200 to operate the desired function.

In conclusion, the invention provides a multi-window information platform user interface which is designed for use in conjunction with an information platform, particularly a portable intelligent electronic device, for providing the information platform with a multi-window user interface that allows the user to operate the various functional options of the information platform concurrently through multiple windows. This feature allows the user to more conveniently and efficiently operate the various functional options of the information platform concurrently at the same time. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A multi-window information platform user interface for use with an information platform equipped with a plurality of functional units for providing the information platform with a multi-window user interface for user-control of the multiple functional units concurrently through multiple windows;
the multi-window information platform user interface comprising:
a parent window activating module, which is capable of being activated in response to a switch-on event on the information platform to display a parent window on the information platform, with the parent window displaying a number of functional options each corresponding to one of the functional units of the information platform; and which is capable of issuing a corresponding child window requesting message in the event of one of the functional options being user-selected;
a child window activating module, which is capable of being activated in response to the child window requesting message from the parent window activating module to activate the opening of a child window that is associated with the user-selected functional option;
a child window operating module, which is capable of responding to a user-initiated child window operating event to operate each opened child window and the function unit associated with the child window; and
a functional unit operating module, which is capable of responding to each operation request message from each opened child window by activating the corresponding functional unit to perform the requested function.

2. The multi-window information platform user interface of claim 1, wherein the information platform is an intelligent mobile phone.

3. The multi-window information platform user interface of claim 1, wherein the information platform is a PDA (Personal Digital Assistant) unit.

4. The multi-window information platform user interface of claim 1, wherein the information platform is an electronic dictionary device.

5. The multi-window information platform user interface of claim 1, wherein the functional units are respectively used to provide a short-message transmitting/receiving function, an Internet browsing function, a wireless voice communication function, and a digital camera function.

6. The multi-window information platform user interface of claim 1, wherein each child window includes a scroll function.
